(19) United States
(12) Patent Application Publication
(10) Pub. No.: US 2003/0160682 A1
(43) Pub. Date: Aug. 28, 2003

(54) Medical communication system

(75) Inventors: Naoki Yamada, Tochigi-Ken (JP); Akio Tetsuka, Tochigi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 10/338,837

(22) Filed: Jan. 9, 2003

(30) Foreign Application Priority Data
Jan. 10, 2002 (JP) 2002-002961
Nov. 19, 2002 (JP) 2002-334989

(51) Int. Cl. G08B 9/00; G08B 23/00

(52) U.S. Cl. 340/286.02; 340/573.1; 340/531; 340/691.6; 340/286.01

(57) ABSTRACT

A medical communication system for exchanging information between a plurality of rooms, comprising transmission means for transmitting information inputted from within one of the rooms, to the other room, and display means for displaying the information received in the other room, as visual information.

As a result, a message or information which is improper when known to a patient or which is not to be known to the patient can be appropriately communicated from the other room to a doctor or the like in one room, without giving the patient a feeling of uneasiness or an unpleasant feeling.

### BACKGROUND OF THE INVENTION

1. Field of the Invention

The present invention relates to a medical apparatus which uses voice information and characters or the like information, and more particularly to a communication system which is employed in means for communicating information of intentions among those engaged in medical service.

2. Description of the Background Art

In, for example, an X-ray fluoroscopic examination diagnosis system wherein the blood vessels of the whole body including the brain, heart, liver, limbs, etc. are examined under X-ray irradiation, an INTERCOM (Intercommunication System) which is based on microphones and speakers is usually employed for the communications and mutual understanding between a doctor who is performing the examination in an examination room and a radiologist who is remote-controlling various equipment in an operation room adjoining the examination room.

FIG. 7A shows a plan sketch of an examination room and an operation room in which an X-ray examination diagnosis system is installed, while FIG. 7B shows the construction of a prior-art intercom based on microphones and speakers as is disposed in the X-ray examination diagnosis system.

Ordinarily, in the X-ray examination diagnosis system, an X-ray fluoroscopic apparatus 74a is installed as shown in FIG. 7A. A patient (not shown) who is to be examined lying on a bed for examination 74b, and a doctor in charge who performs the examination, are in the examination room 71 for which X-ray shielding is executed. A radiologist who performs the remote control of the X-ray fluoroscopic apparatus 74a and the filing operation of examination records such as examination data and examination images, remote-controls equipment in the operation room 72 adjoining the examination room 71 and over a lead glass window 77 while avoiding exposure to X-rays, by the operating console of an operation table 73 in accordance with the instructions of the doctor in charge.

The instructions from the doctor who is performing the examination are transmitted to the radiologist in such a way that voice picked up by a fixed microphone 76a mounted on the wall, ceiling or the like of the examination room 71, or a pin microphone attached to the gown of the doctor is broadcast as amplified voice from the speaker 75a of the operation room 72. On the other hand, matters to be communicated from the radiologist are usually picked up by a microphone 76b put on the operation table 73 and then transmitted to the doctor similarly as amplified voice by a speaker 75b mounted on the wall of the examination room 71. Such schemes constitute a so-called “interphone system” which is constructed of the speakers 75a, 75b and the microphones 76a, 76b as shown in FIG. 7B. They are facilities which are installed as respectively separate systems, and which are not associated with the X-ray fluoroscopic examination diagnosis system itself.

Owing to the vocal intercom arranged in the examination room and the operation room as stated above, the doctor in the examination room gives the radiologist in the operation room the instructions for projecting a real-time fluoroscopic image and past image data being reference materials, on the monitor 78 of the examination room 71, and also, for changing-over the screens of the monitoring data of patient organism signals, moving the X-ray fluoroscopic apparatus 74a to a part to-be-examined and setting the fluoroscopic conditions thereof, and so forth. On the other hand, the radiologist in the operation room 72 chiefly inquires about or confirms the propriety of each operation, but he/she also transmits a message from within a hospital to the doctor being in the shielded and isolated examination room, especially information or an inquiry about another patient of the doctor in charge, and so forth.

With the prior-art vocal intercom installation which is disposed between the examination room and the operation room equipped with the X-ray fluoroscopic examination diagnosis system, when the doctor in the examination room is inquired of or consulted as stated above, the contents of the inquiry or consultation about the other patient, for example, are heard by the subject patient who is a third party other than those engaged in medical service, because the subject patient is usually under examination while keeping himself/herself awake. Therefore, such circumstances are sometimes inappropriate for the reasons that privacy is not protected and that an unpleasant feeling is given to the subject patient. It is unfavorable for diagnosis and treatment that especially the inquiry about the subject patient or the situation of his/her diseased part, etc. are heard by the patient himself/herself.

Besides, much noise from the installed equipment is heard inside the examination room and the operation room, and the vocal information is momentary and is liable to be missed or heard wrong. Further, in some cases, the vocal information is difficult to be reconfirmed after the lapse of a time period, and it brings about a slip of memory. After all, the prior-art intercom which permits the communications between the examination room and the operation room only vocally has been problematic as means for allowing the doctor in charge and the radiologist who are the parties concerned, to reach mutual understanding sufficient for implementing the business of medical care including the examination.

Incidentally, there has been known an example wherein, as disclosed in Japanese Patent Disclosure (Kokai) No. 2000-342562, a display apparatus is disposed in a roentgen examination room, whereby a message for a person to be radiographed is rendered by displaying it on the display apparatus. More specifically, the display apparatus is intended to display any of typical instructional messages for the person to-be-radiographed under roentgen examination. A plurality of such typical instructional messages are stored beforehand, and an operator selects the message to-be-displayed from among the stored ones so as to display the selected message on the display apparatus. In this case, however, when the sorts of the messages to be stored are made larger in number, the operator bears a heavier burden to that extent in selecting the message, so that the sorts of the messages to be stored are limited.

There has also been known an apparatus wherein voice is transformed into characters as disclosed in Japanese Patent Disclosure (Kokai) No. 11-143487. However, the apparatus is a general-purpose apparatus for voice-to-character transformation, and the application thereof to medical use is not referred to at all. That is, problems peculiar to the site of medical service are not considered at all.

### SUMMARY OF THE INVENTION

The present invention has for its object to provide a medical communication system according to which a doctor or the like being in one room and another person engaged in medical service, or the like being in the other room can reach mutual understanding without being heard by a patient or a third party.

In order to accomplish the object, the present invention consists in a medical communication system for exchanging information between a plurality of rooms, characterized by comprising transmission means for transmitting information inputted from within one of the rooms, to the other room; and display means for displaying the information received in the other room, as visual information.

Besides, the present invention consists in a medical communication system for exchanging information between a plurality of rooms, characterized by comprising transmission means for transmitting information inputted from within one of the rooms, to the other room; and output means for outputting the information received in the other room, as aural information.

Further, the present invention consists in a medical communication system for exchanging information between a plurality of rooms, characterized by comprising transmission means for transmitting information inputted from within one of the rooms, to the other room; display means for displaying the information received in the other room, as visual information; and notification means for giving notice that the information has been received in the other room.

According to the present invention, a message or information which is improper when known to a patient or which is not to be known to the patient can be appropriately communicated from the other room to a doctor or the like in one room, without giving the patient a feeling of uneasiness or an unpleasant feeling.

### BRIEF DESCRIPTION OF THE DRAWINGS

FIG. 1 is a system architecture diagram of a medical communication system according to the present invention;

FIGS. 2A and 2B exemplify screen displays for confirming character information in the medical communication system of the present invention;

FIGS. 3A and 3B exemplify screen displays presented in an examination room in the medical communication system of the present invention;

FIGS. 4A and 4B exemplify the screen displays of character information which is displayed in superposition on a fluoroscopic image in the medical communication system of the present invention;

FIGS. 5A and 5B exemplify the screen displays of character information which is displayed in an operation room in the medical communication system of the present invention;

FIGS. 6A and 6B exemplify screen displays in the case where character information is displayed on display apparatuses dedicated to the character information, in the medical communication system of the present invention;

FIGS. 7A and 7B are a sketch of an X-ray examination diagnosis system installation in which a prior-art intercom is disposed, and a constructional view of the prior-art intercom, respectively; and

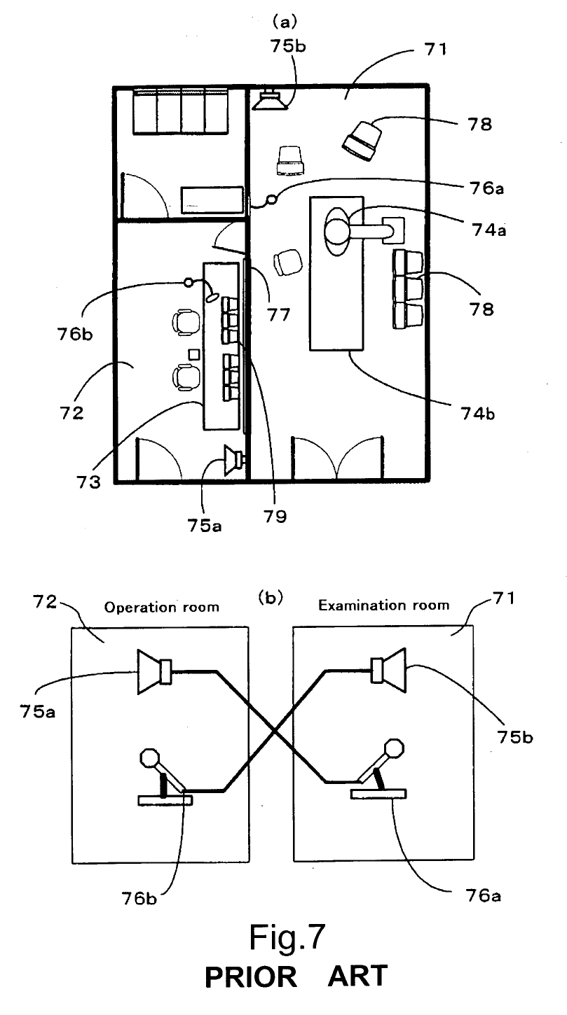

FIGS. 8A through 8D are diagrams for explaining examples of image information, symbols, marks, etc. which are used for the transmission of information instead of or together with character information in the present invention.

### DETAILED DESCRIPTION OF THE PREFERRED EMBODIMENTS

An embodiment of the present invention will be described in detail with reference to the drawings.

A character intercom according to the present invention is applicable in the case of establishing communications or mutual understanding between medical facilities such as an examination room, a treatment room or an operating room (namely, surgery) which require special protection or isolation in examination or treatment, and medical facilities such as an operation room or a nurse station for which the protection or isolation is not very severe. One embodiment of the present invention will be described as to a case of applying the invention to the examination room in which an X-ray fluoroscopic examination diagnosis system is installed, and the operation room for the system.

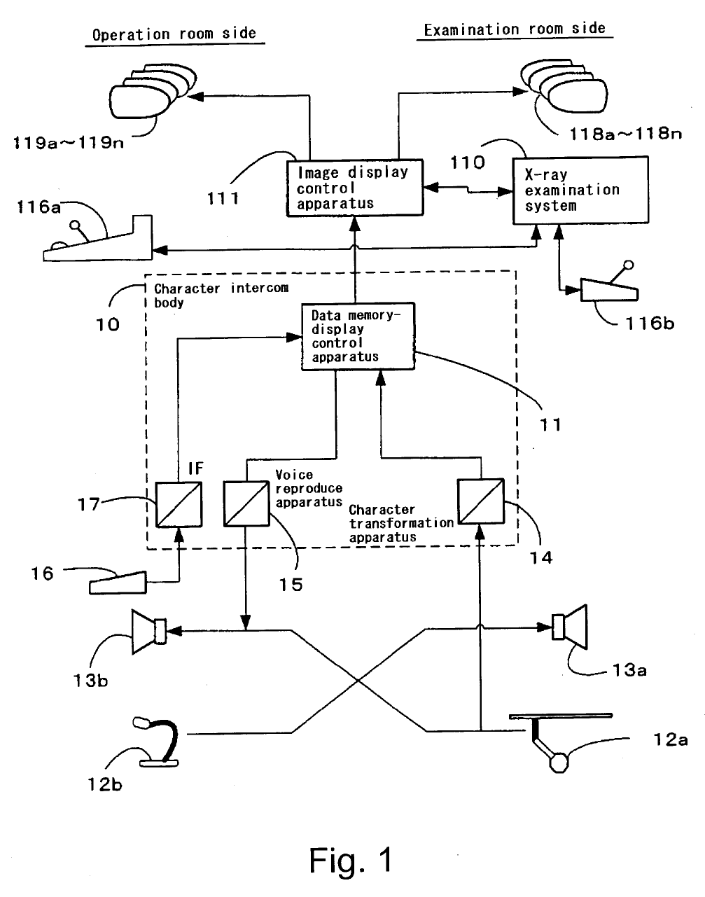

FIG. 1 is a system architecture diagram showing the embodiment of the character intercom for medical use in the present invention. According to the medical character intercom of this embodiment, in the examination room which a patient and a doctor in charge enter to perform examination, there are disposed a microphone 12a by which the doctor communicates to the operation room, a speaker 13a by which voice information from the operation room is broadcast, and display apparatuses 118a-118n which display diagnostic images radiographed and gathered by the X-ray examination diagnosis system 110 in the examination room, and one 118a of which is assigned to display character information A communicated from the operation room.

On the other hand, in the operation room, there are disposed a microphone 12b which sends voice information to the examination room, a speaker 13b which broadcasts communication from the examination room, a keyboard 16 by which the character information A to be displayed on the display apparatus 118a of the examination room is inputted, a display apparatus 119a which presents a display for confirming the input of the character information A, and the display of character information B obtained in such a way that voice made by the doctor in the examination room is recognized and transformed into characters, and a character intercom body 10 which processes the character information A and the character information B.

Incidentally, the display apparatus 119a is assigned as one of display apparatuses 119a-119n which are disposed in the operation room, and which display the same diagnostic images radiographed and gathered by the X-ray examination diagnosis system 110 in the examination room and displayed in this examination room. Besides, the character intercom body 10 is constructed of a character transformation interface (IF) 17 by which key information from the keyboard 16 is transformed into character codes so as to obtain the character information A, a voice-to-character transformation apparatus 14 by which voice information picked up by the microphone 12a in the examination room is recognized and is transformed into the character information B, a data memory/display control apparatus 11 which accumulates and stores the voice information and the character information and which performs the input/output controls of the information, and a voice reproduction apparatus 15 by which the voice data stored in the data memory/display control apparatus 11 are reproduced and broadcast by the speaker 13b in the operation room.

Further, since the large numbers of display apparatuses 118a-118n and 119a-119n for displaying fluoroscopic images, patient organism data are respectively installed in the examination room and the operation room, an examination-diagnosis-image display control apparatus 111 is disposed so as to display the character information of the present embodiment on these display apparatuses in multiple fashion.

The character information A which is inputted from the operation room so as to be displayed in the examination room, and the character information B which is obtained by transforming the voice information in the examination room, are distinctively inputted from the data memory/display control apparatus 11 included in the character intercom body 10, to the examination-diagnosis-image display control apparatus 111. Similarly inputted to the examination-diagnosis-image display control apparatus 111 are diagnostic image data which are radiographed and gathered by the X-ray examination diagnosis system 110 in such a way that the radiologist in the operation room operates an operation table 116a under the instructions of the doctor, or that the doctor in the examination room operates a bedside controller 116b. The character information and the image data thus inputted are outputted to and displayed on the display apparatuses 118a-118n and 119a-119n allocated by the examination-diagnosis-image display control apparatus 111.

Next, the operation of this embodiment of the medical character intercom according to the present invention will be described using examples of the display screens of the character information. First, there will be described the operation of an embodiment which concerns the character information A of the medical character intercom according to the present invention.

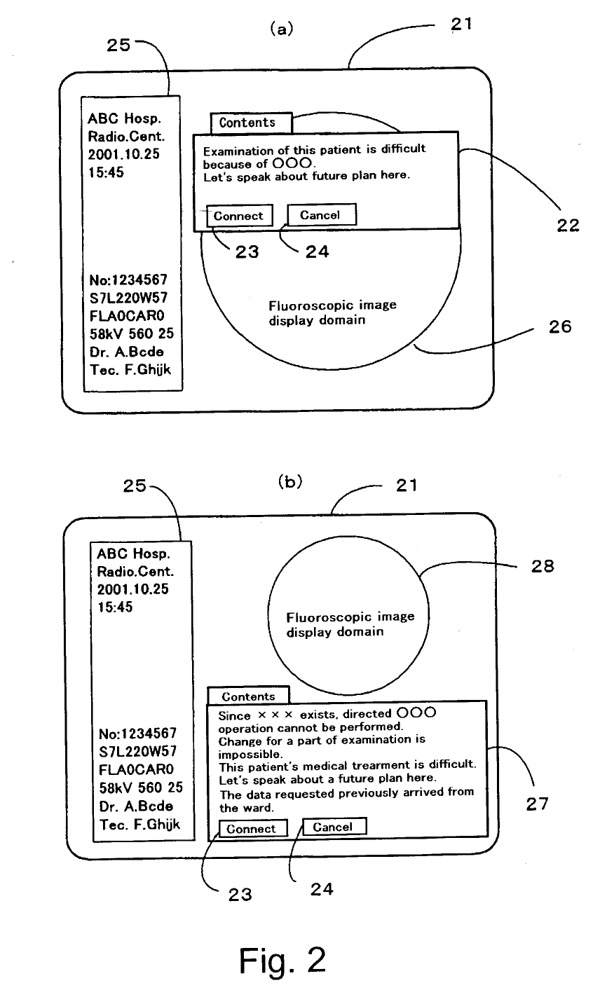

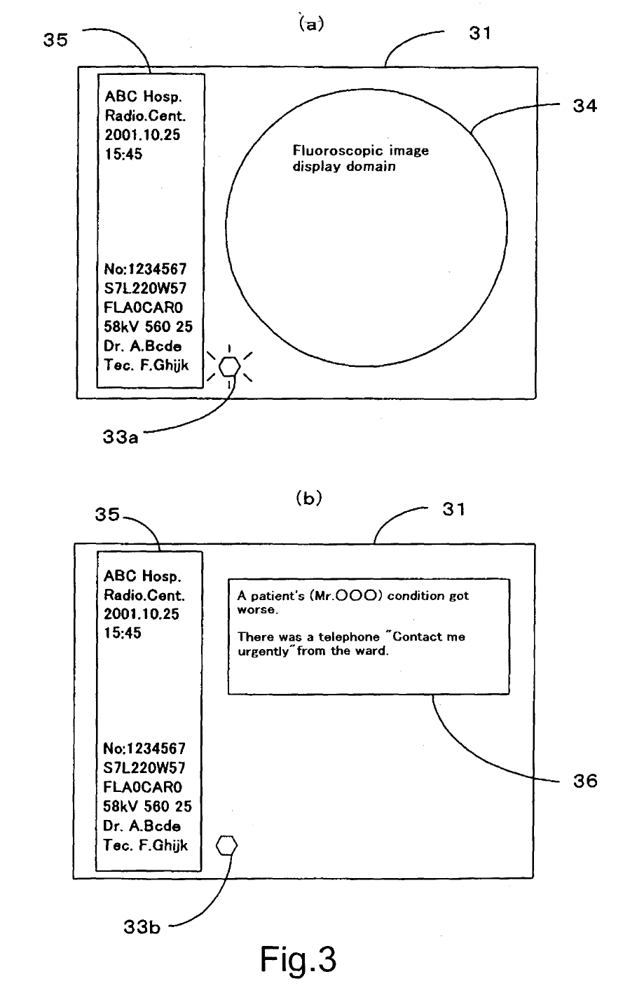

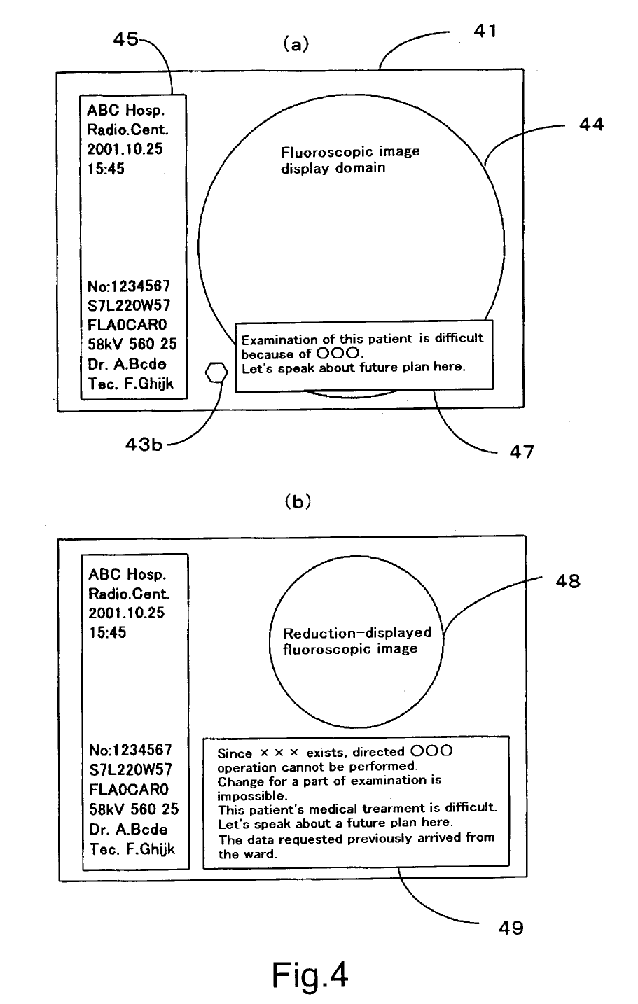

FIGS. 2A and 2B exemplify screens for confirming the character information A which is displayed on the display apparatus 119a in the operation room, and FIG. 2A shows a case of displaying the character information A in superposition on a fluoroscopic image, while FIG. 2B shows a case of displaying the character information A with a fluoroscopic image reduced. FIGS. 3A and 3B exemplify the displays of the character information A which is displayed on the display apparatus 118a in the examination room, and FIG. 3A shows a case where the arrival of the character information A from the operation room is displayed on a screen displaying a fluoroscopic image, while FIG. 3B shows a case where the character information A is displayed by interrupting the fluoroscopic image display. Besides, FIGS. 4A and 4B show display examples in each of which a fluoroscopic image and the character information A are simultaneously displayed on the display apparatus 118a in the examination room, and FIG. 4A shows a case of displaying the character information Ain superposition on the fluoroscopic image, while FIG. 4B shows a case of displaying the character information A with the fluoroscopic image reduced.

Ordinary conversation, communication not giving offense to the patient, etc. toward the doctor in the examination room from the radiologist who is operating the X-ray examination diagnosis system 110 in the operation room in accordance with the doctor's instructions, are vocally inputted from the microphone 12b in the operation room and are broadcast as voice information from the speaker 13a in the examination room.

In contrast, when information which is not to be heard by the patient is to be communicated to the doctor in the examination room, the radiologist operates the keyboard 16 in the operation room and inputs contents to-be-communicated. The inputted communication contents are transformed into character information by the character transformation interface (IF) 17, and the character information is inputted as the character information A to the examination-diagnosis-image display control apparatus 111 via the data memory/display control apparatus 11. The inputted character information A is superposed on real-time diagnosis image data from the X-ray examination diagnosis system 110, and is transformed by the examination-diagnosis-image display control apparatus 111 into image screen data which are displayed as, for example, a display domain 22 superposed on a diagnostic image display domain 26 as shown in FIG. 2A. The transformed screen data are outputted and displayed as data for confirming the character information A, on any preset display apparatus 119a among the display apparatuses 119a-119n in the operation room.

The radiologist in the operation room confirms the inputted communication contents on the screen 21 of the display apparatus 119a, and subject to no problem in the contents, he/she clicks a “Connect” icon 23 displayed on the screen or presses a “Connect” key (not shown) set in the keyboard 16. When the signal of the click or keying is inputted to the examination-diagnosis-image display control apparatus 111, this display control apparatus 111 flickers or blinks a mark 33a for displaying the transmission of the character information A, on a screen for displaying real-time diagnosis image data, for example, a screen 31 shown in FIG. 3A, on that one 118a of the display apparatuses 118a-118n in the examination room which is set at a position not seen by the patient, and it stands by for transmitting the data of the character information A to the display apparatus 118a.

The doctor in the examination room who has seen the sign of the flickering and has judged a situation where the examination diagnosis can be interrupted in order to read the communication, clicks the button of the display mark 33a on the screen 31 or presses a switch or a key set in the X-ray examination diagnosis system 110 near at hand, thereby to issue the signal of “OK”. Then, the examination-diagnosis-image display control apparatus 111 displays image data containing the data of the character information A on the display apparatus 118a in the examination room, for example, it displays the character information A in a superposition domain 47 in superposition on a real-time diagnosis image domain 44 as shown in FIG. 4A.

In a case where the doctor in the examination room has read the character information A and where the display thereof has become unnecessary, the doctor clicks an unflickering display mark 43b again or operates a switch or the like set in the bedside controller 116b, thereby to issue a “Clear” signal. Then, the examination-diagnosis-image display control apparatus 111 stops the output 47 of the data of the character information A and the display mark 43b, and it restores the screen 34 of the original real-time diagnosis image data display.

By the way, in displaying the character information A, it is also possible by settings in the examination-diagnosis-image display control apparatus 111 that, as shown in FIG. 3B, the display of the real-time diagnosis image data be interrupted to display the data of the character information A as communication sentence information 36. Besides, in a case where the character information A is a long sentence or where a real-time diagnosis image is desired to be observed simultaneously with the display of the character information A, it is similarly possible by settings in the examination-diagnosis-image display control apparatus 111 that, as shown in FIG. 2B on the operation room side or FIG. 4B on the examination room side, real-time image data be presented as a reduced display 28 or 48 so as to simultaneously display the character information A 27 or 49 at a part where the diagnosis image data are not displayed.

Besides, although the example of flickering the display mark 33a on the screen of the display apparatus 119a has been mentioned for reporting the fact that the character information A has been sent out from the operation room, a sign can also be made in such a way that an acoustic or optical display unit (not shown) is separately disposed, and that the drive of the display unit is set in the data memory/display control apparatus 11.

On the other hand, when the radiologist is to cancel the “Connect” after having inputted the communication contents from the keyboard 16, he/she clicks a “Cancel” icon 24 in FIG. 2A or FIG. 2B or presses a “Cancel” key (not shown) set in the keyboard 16. Then, the data memory/display control apparatus 11 can output a signal so as to cancel the sending-out of the character information A from the examination-diagnosis-image display control apparatus 111 to the display apparatus 118a.

Besides, it can be carried out in the same manner as taught in the present embodiment to dispose a character intercom from the examination room to the operation room in order that the doctor in the examination room may communicate contents which are not to be heard by the patient, to the person concerned in the operation room. With the character intercom, the continuation or interruption of examination or treatment can be coped with on the judgment of the doctor himself/herself who is governing the control of the examination or the like. A medical care action, such as examination or treatment, which proceeds in the examination room ought to be performed with preference taken over a keyboard operation in the examination room. Although character intercom means based on the keyboard operation from the examination room is not stated in the present embodiment, it is employed for the purpose of reliably communicating without being heard by the patient, in an exceptional situation where contents which are not to be known to the patient need to be frequently communicated from the examination room to the operation room.

Information items which are communicated from the radiologist in the operation room to the doctor in the examination room, include many contents which are inappropriate when known to the patient in the examination room. In the medical character intercom taught in the present embodiment, however, the contents are displayed as the character information on the display apparatus which only the doctor can watch, and hence, the mutual understanding between the doctor and the person concerned in the medical service can be reached without letting the patient know the contents. Moreover, since the display is maintained till being cleared, the doctor can confirm the communication at an appropriate time after he/she has ended a series of medical treatment steps. It is accordingly possible to lighten the burden of the medical care action to the doctor and to enhance the quality of this action.

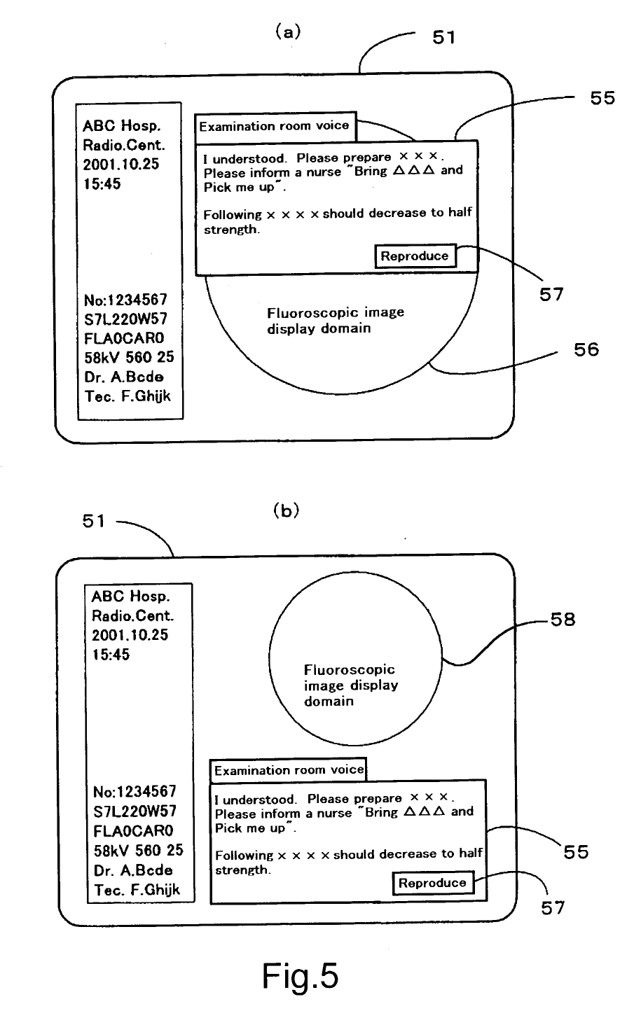

Next, there will be described the operation of an embodiment which concerns the character information B of the medical character intercom according to the present invention. FIGS. 5A and 5B show display examples of the character information B in each of which voice information in the examination room to be displayed on the display apparatus in the operation room has been transformed into the character information, and FIG. 5A shows a case of displaying the character information B in superposition on a fluoroscopic image, while FIG. 5B shows a case of displaying the character information B with a fluoroscopic image reduced.

The voice information produced by the doctor in the examination room is picked up by the microphone 12a shown in FIG. 1, and is directly broadcast in the operation room by the speaker 13b connected to this microphone 12a. Meanwhile, the voice information produced by the doctor is recognized and is further transformed into characters by the voice-to-character transformation apparatus 14 which is similarly connected to the microphone 12a, and such transformed results are stored as the character information B in the memory of the data memory/display control apparatus 11 with serial Nos. or time tags affixed thereto. Besides, the voice information items themselves are similarly stored in the memory of the data memory/display control apparatus 11 in parallel in an analog or digital data format and by affixing thereto identification codes correspondent to the data of the character information B.

In a case where a selection instruction signal for the character information B is not issued by the keyboard 16 or the operation table 116a in the operation room and where the voice information of the doctor in the examination room is sequentially transformed into characters, part of the character information B already stored, with a prescribed number of display lines traced back so that the latest stored character information of the transformed and stored character information B may become the last line, is read out from the data memory/display control apparatus 11 and is inputted to the examination-diagnosis-image display control apparatus 111 as a data group which is to be displayed on any preset one 119a of the display apparatuses 119a 119n in the operation room.

In the examination-diagnosis-image display control apparatus 111, the data group which is the read-out part of the character information B is processed so as to be displayed as an examination room voice domain 55 in the form of, for example, a screen 51 as shown in FIG. 5A. The processed data group is outputted and is displayed on the screen of any preset one 119a of the display apparatuses 119a-119n in the operation room.

Incidentally, when the doctor in the examination room has produced the next voice information, the above display contents are updated so that the latest character information may become the last line, and an updated data group is read out again from the data memory/display control apparatus 11 and is inputted to the examination-diagnosis-image display control apparatus 111. In the examination-diagnosis-image display control apparatus 111, the updated data group is processed again so as to be displayed as the examination room voice domain 55, and the processed data group is outputted to the display apparatus 119a again, whereby the display is updated.

Subsequently, the radiologist in the operation room operates the pointer or cursor of the character information B from the keyboard 16 or the operation table 116a in the operation room in order to confirm an instruction or communication vocally issued by the doctor in the examination room before. Then, part to be read out from the accumulated and stored character information B is altered to a data group centering round a line on which the pointer is located, in the data memory/display control apparatus 11, and the data group is inputted to the examination-diagnosis-image display control apparatus 111. The output from the examination-diagnosis-image display control apparatus 111 to the display apparatus 119a in the operation room is altered, and the examination room voice 55 in FIG. 5A or FIG. 5B is scrolled in the vertical movement direction of the pointer or cursor.

The radiologist clicks a “Reproduce” icon 57 on the screen 51 or presses a button or key preset as “Reproduce” in the keyboard 16 or operation table 116a, at the desired part of the communication sentence. Then, voice information which is held stored in the memory of the data memory/display control apparatus 11 in an analog or digital data format while bearing an identification code correspondent to the desired data of the character information B is inputted to the voice reproduction apparatus 15, and a reproduced voice signal is broadcast from the speaker 13b in the operation room. Thus, the voice information issued by the doctor can be reproduced and confirmed as voice information substantially close to a human voice though the reproduction depends also upon the scheme of data compression.

On the other hand, voice information in the operation room is picked up by the microphone 12b and is directly broadcast by that speaker 13a of the examination room which is connected to this microphone.

Incidentally, although the reproduction of the voice information in the examination room has been explained as to the example of reproducing the analog or digital conversion data of the voice information stored in the data memory/display control apparatus 11, the conversion data of the voice information require a very large memory capacity. In this regard, it is also allowed to store only character information data in the processing of the character information B in the data memory/display control apparatus 11, and to construct a voice reproduction apparatus so that the character information data designated by a selection instruction operation from the operation room may be reproduced by speech synthesis means. Even in this case, the effect of confirming voice information issued in the past, in terms of character information and reproduced voice information, as is one of the objects of the present embodiment can be similarly attained though a voice quality differs from a human voice.

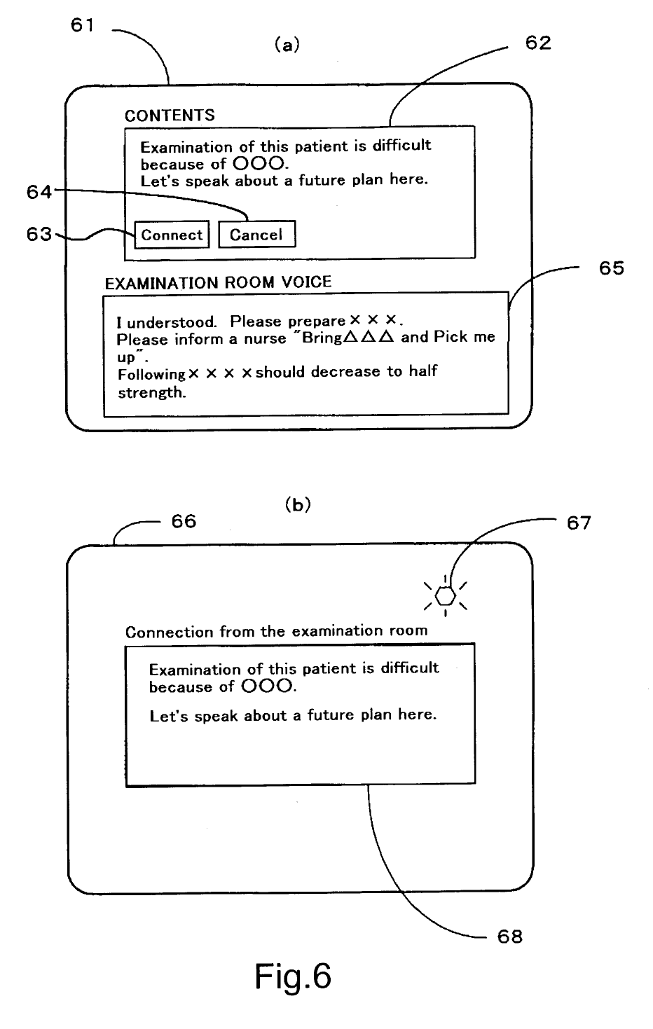

In the above-described embodiment, there has been mentioned the example in which the character information is superposedly displayed on the preset ones of the examination-diagnosis-image display apparatuses which are installed in large numbers in the examination room and the operation room. However, the image display apparatuses 118a, 119a respectively assigned to the examination room and the operation room may well be changed-over to display screens dedicated to character information, in accordance with an output from the data memory/display control apparatus 11, thereby to present a screen display shown in FIG. 6A in the operation room and a screen display shown in FIG. 6B in the examination room. Thus, it is possible to provide a medical character intercom which permits reliable communications without being heard by the third party such as patient, and through which the doctor and the radiologist can exactly understand their intentions.

Important communications and instructions which are issued in terms of voice information from the doctor in the examination room to the radiologist in the operation room, exist only temporarily. With the character information B of the medical character intercom shown in the present embodiment, however, the vocal communications and instructions are transformed into character information, which is displayed on the display apparatus of the operation room. Although the communications etc. might be missed or heard wrong only with the voice information, they can be confirmed as the character information in accordance with the embodiment of the present invention, to bring forth the advantage that the missed or wrong communications etc. can be avoided to prevent misoperations ascribable thereto from occurring. Besides, since the voice information is held stored in correspondence with the character information, the radiologist can confirm the voice information by reproducing it within the operation room, without throwing back a question which is troublesome to the doctor in the examination room. That is, even after the lapse of time, the contents of the received information can be reconfirmed on the receiving side. Accordingly, the present embodiment can enhance the qualities of the communications and mutual understanding between the doctor in the examination room and the radiologist operating the equipment in the operation room, and it also produces the effect that the doctor can devote himself/herself to examination and diagnosis.

Meanwhile, the above embodiments have been described concerning the case where messages or instructions are given between the radiologist in the operation room and the doctor in the examination room. However, one of the rooms is not restricted to the examination room, but it may well be a room such as treatment room or catheter room, and the other is not restricted to the operation room, either. In general, the present invention is applicable to the communications of information among a plurality of rooms.

Besides, the above embodiments have been described concerning the case where the character information is transmitted by the display apparatus. The transmission by the display apparatus has the advantage that the contents can be correctly conveyed. However, the present invention can also transmit display contents by a display medium such as electric bulletin board, and the display contents can further be flickered. With such a display medium, even in a case, for example, where a job is proceeding in a place distant from the display medium, the contents to be transmitted can be conveyed, and the flickering brings forth the advantage that more attention can be called.

Besides, the above embodiments have been described concerning the case where the voice information is transformed into the character information and is transmitted as such. The character information brings forth the advantage that contents to be transmitted can be correctly conveyed.

However, the present invention is not restricted to the transmission by the character information, but it can also employ sounds other than the voice, such image information as pictorial symbols, pictures or marks, or/and such a method as lighting in different colors (including flickering) or combining any of the means with the character information. In the case of employing such means, the significances of the sounds, image information, or the colors of the lighting may be defined beforehand.

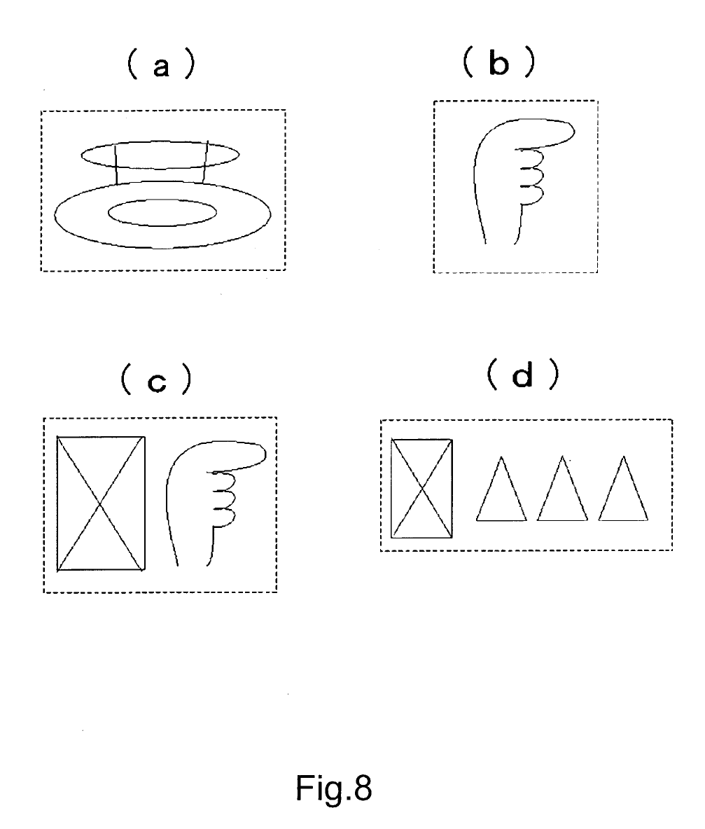

By way of example, when the mark of a telephone set as shown in FIG. 8A is displayed, “Doctor, there was a telephone call” shall be signified. Besides, when the mark of a hand as shown in FIG. 8B is displayed, “Let's speak about the future plan of medical treatment here” shall be signified. Further, the symbol of square bearing X shall signify that an operation cannot be performed, and the combination of this symbol and the mark of a hand as shown in FIG. 8C shall signify “The directed operation cannot be performed. Let's speak about the future plan of medical treatment here.”

Besides, the combination of the above symbol of square bearing X and characters (ΔΔΔ) as shown in FIG. 8D by way of example shall signify “The directed operation cannot be performed. ΔΔΔ exists in the patient.” When, in this manner, words of comparatively frequent use are expressed by marks, image information and symbols and are displayed in combination with character information, advantageously they are easy of understanding and can correctly transmit their contents. It is also possible that voices corresponding to the marks, image information and symbols be displayed as the marks, etc. themselves, while the other parts be displayed as characters after being transformed by the voice-to-character transformation apparatus.

Further, in the case where contents are transmitted by lighting in different colors, it can be defined beforehand by way of example that red lighting signifies “The directed operation cannot be performed”, that yellow lighting signifies “Doctor, there was a telephone call”, that blue lighting signifies “Doctor, I understood the directed operation”, and that blue flickering signifies “The operation is being performed”. When the significances of the lighting and flickering are predefined in this manner, advantageously the transmitted contents can be readily understood even during jobs without being finely read.

What kinds of symbols, marks or image information and characters are to be used, or how they are to be combined, can be properly determined depending upon circumstances such as what sorts of jobs proceed in rooms between which communications are to be established, if display media such as display apparatuses are disposed in the rooms beforehand, and whether contents to be communicated are complicated or simple.

What is claimed is:

1. A medical communication system for exchanging information between a plurality of rooms, comprising:
transmission means for transmitting information inputted from within one of the rooms, to the other room; and
display means for displaying the information received in the other room, as visual information.

2. A medical communication system of claim 1, further comprising transformation means for transforming the inputted information into character information;
wherein the display means displays the character information as the visual information.

3. A medical communication system of claim 2, wherein the inputted information is voice information.

4. A medical communication system of claim 1, wherein:
the inputted information is information selected from among a plurality of preset character information items; and
the display means displays image information corresponding to the selected character information.

5. A medical communication system of claim 1, wherein:
the inputted information is information selected from among a plurality of preset character information items; and
the display means displays color information corresponding to the selected character information.

6. A medical communication system of claim 1, wherein the other room is an examination room.

7. A medical communication system of claim 1, wherein the other room is a catheter room.

8. A medical communication system of claim 1, wherein the other room is a medical treatment room.

9. A medical communication system of claim 6, wherein the display means is capable of displaying an image for examination.

10. A medical communication system of claim 9, wherein the display means is capable of displaying the visual information and the image for examination in changeover fashion.

11. A medical communication system of claim 9, wherein the display means is capable of displaying the visual information and the image for examination in superposition.

12. A medical communication system of claim 7, wherein the display means is capable of displaying an image for examination or medical treatment using a catheter.

13. A medical communication system of claim 12, wherein the display means is capable of displaying the visual information and the image for examination or medical treatment using a catheter in changeover fashion.

14. A medical communication system of claim 12, wherein the display means is capable of displaying the visual information and the image for examination or medical treatment using a catheter in superposition.

15. A medical communication system of claim 8, wherein the display means is capable of displaying an image for medical treatment.

16. A medical communication system of claim 15, wherein the display means is capable of displaying the visual information and the image for medical treatment in changeover fashion.

17. A medical communication system of claim 15, wherein the display means is capable of displaying the visual information and the image for medical treatment in superposition.

18. A medical communication system for exchanging information between a plurality of rooms, comprising:
transmission means for transmitting information inputted from within one of the rooms, to the other room; and
output means for outputting the information received in the other room, as aural information.

19. A medical communication system of claim 18, wherein:
the inputted information is information selected from among a plurality of preset character information items; and
the output means outputs aural information corresponding to the selected character information.

20. A medical communication system of claim 18, wherein the other room is an examination room.

21. A medical communication system of claim 18, wherein the other room is a catheter room.

22. A medical communication system of claim 18, wherein the other room is a medical treatment room.

23. A medical communication system for exchanging information between a plurality of rooms, comprising:
transmission means for transmitting information inputted from within one of the rooms, to the other room;
display means for displaying the information received in the other room, as visual information; and
notification means for giving notice that the information has been received in the other room.

24. A medical communication system of claim 23, wherein the notification means gives the notice by sound or a lighting display of visual information.

25. A medical communication system for exchanging information between a plurality of rooms, comprising:
a voice-to-character transformation apparatus configured to transform a voice information inputted from within one of the rooms into a character information; and
a display apparatus configured to display the character information received in the other room.

26. A medical communication system of claim 25, further comprising an examination-diagnosis-image display control apparatus configured to display a diagnostic image data.

27. A medical communication system of claim 26, wherein the examination-diagnosis-image display control apparatus configured to display the character information and the diagnostic image data in changeover fashion.

28. A medical communication system of claim 26, wherein the examination-diagnosis-image display control apparatus configured to display the character information and the diagnostic image data in superposition.
